(19) United States
(12) Patent Application Publication
(10) Pub. No.: US 2016/0247655 A1
(43) Pub. Date: Aug. 25, 2016

(54) TARGET AND/OR FILAMENT FOR AN X-RAY TUBE, X-RAY TUBE, METHOD FOR IDENTIFYING A TARGET AND/OR A FILAMENT AND METHOD FOR SETTING THE CHARACTERISTICS OF A TARGET AND/OR A FILAMENT

(71) Applicant: YXLON INTERNATIONAL GMBH, Hamburg (DE)

(72) Inventors: Willhelm NIEMANN, Norderstedt (DE); Bjoern SCHRADER, Hamburg (DE); Jens DEYE, Hamburg (DE); Axel KLEIN, Hamburg (DE)

(21) Appl. No.: 15/030,899

(22) PCT Filed: Oct. 21, 2014
(86) PCT No.: PCT/EP2014/002839

§ 371 Date: Apr. 21, 2016

(30) Foreign Application Priority Data
Oct. 21, 2013 (DE) 10 2013 017 463.5

(51) Int. Cl. H01J 35/02; H01J 35/06; H01J 35/08

(52) U.S. Cl. CPC H01J 35/025; H01J 35/08; H01J 35/06

(57) ABSTRACT

A target and/or a filament is provided for an X-ray tube. The target includes a target base. A target element is attached to the target base. An identification element is attached to the target base. The identification element is configured to be identified in cooperation with an acquisition element on the X-ray tube and which has an unambiguous assignment to characteristics of the target. The filament for an X-ray tube includes a filament holder. A filament element is attached to the filament holder. An identification element is attached to the filament holder. The identification element is configured to be identified in cooperation with an acquisition element on the X-ray tube and which has an unambiguous assignment to characteristics of the filament.

### CROSS-REFERENCE TO PRIOR APPLICATIONS

This application is a U.S. National Phase Application under 35 U.S.C. §371 of International Application No. PCT/2014/002839, filed on Oct. 21, 2014, and claims benefit to German Patent Application No. DE 10 2013 017 463.5, filed on Oct. 21, 2013. The International Application was published in German on Apr. 30, 2015 as WO 2015/058853 under PCT Article 21(2).

### FIELD

The invention relates to a target and/or a filament for an X-ray tube, to an X-ray tube which has such a target and/or such a filament, to a method for identifying such a target and/or such a filament and to a method for setting the characteristics of such a target and/or such a filament.

### BACKGROUND

X-radiation sources are known from the state of the art which can be roughly divided into two groups—closed and open tubes.

The closed tubes are fixed in terms of their parameters and properties from production, i.e. the vacuum is generated during the production and there is no possibility after the production to implement modifications to the tube.

The situation is different with the open tubes. Here the vacuum of the tube is only generated during the operation and can be released again if necessary (opening of the tube). The open tubes thus have several key advantages. Firstly, defective parts can be replaced and, much more significantly, the properties of the tubes can be changed by the replacement of components.

Precisely in the field of high-resolution X-ray tubes, for example, it can be necessary to change the focal spot size or the power output according to the application case. This can take place by using a suitable target.

The operator thus has the freedom to select the suitable target for his application/inspection task from different targets.

For each of these targets there is an appropriate set of parameters—called characteristics in the following—in the tube control system, which ensures the optimal and safe operation of the X-ray tube with the target. An incorrect set of parameters inevitably leads to poor inspection results up to destruction of the target.

At present, it is necessary for the operator to select and set the necessary parameters on the tube control system appropriately for the target. This manual intervention in the system results from the fact that, due to the installation situation in the X-ray tube, there is no possibility of identifying the target.

X-ray tubes are formed either as transmission tube heads—in the case of these the electron beam strikes the target perpendicularly and the X-radiation is emitted by the target—or as directional tube heads—in the case of these the electron beam strikes the target at an angle and the X-radiation leaves the same surface at the corresponding exit angle.

The further descriptions and observations are represented using the example of a transmission tube head; however, they are analogously transferable to a directional tube head and thus apply to all open tubes. In principle, closed tubes are no different in this regard—as is clear to a person skilled in the art—with the result that the embodiments are also essentially transferable to these.

### SUMMARY

One embodiment of the invention is a target for an X-ray tube, including a target base. A target element is attached to the target base. An identification element is attached to the target base. The identification element is configured to be identified in cooperation with an acquisition element on the X-ray tube and which has an unambiguous assignment to characteristics of the target.

Another embodiment of the invention is a filament for an X-ray tube, including a filament holder. A filament element is attached to the filament holder. An identification element is attached to the filament holder. The identification element is configured to be identified in cooperation with an acquisition element on the X-ray tube and which has an unambiguous assignment to characteristics of the filament.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic representation of a prior art X-ray tube.

FIG. 2 is a view of a target with electrical identification element according to an embodiment of the invention.

FIG. 3 is the target from FIG. 2 in the installed state.

FIG. 4 is a schematic representation of a method using resistance measurement according to an embodiment of the invention.

FIG. 5 is a representation of a rotating target with barcode.

FIG. 6 is a representation of a fixed target with barcode in the non-installed state.

FIG. 6a is a representation of the target from FIG. 6 in the installed state.

FIG. 7 is a representation of a target with mechanical identification element in the non-installed state.

FIG. 7a is a representation of the target from FIG. 7 in the installed state.

FIG. 8 is a schematic representation of a conventional target and a target for implementing an identification by “defocusing”.

### DETAILED DESCRIPTION

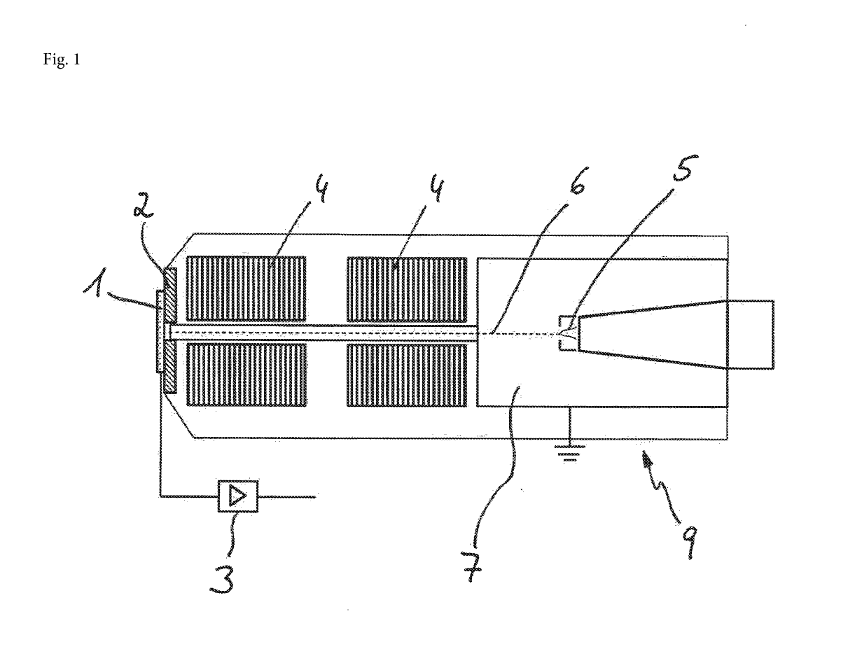

The target identification is problematic. With reference to FIG. 1, the structure of an X-ray tube 9 is explained schematically. The target 1 is located at an exposed location of the head of the X-ray tube 9 which consists in large parts of solid iron. This installation location is distinguished by its high operating temperature, high radiation dose and the magnetic fields of the focusing coil. For the regulation and control of the X-ray beam it is necessary to measure the electron beam 6 striking the target 1—more accurately, striking the target element 11, 11a, 11b. This is realized by a target current measuring device 3. This measurement requires a high measurement accuracy in the region of 1-3000 μA. For this measurement, it is necessary to install the target element 11, 11a, 11b such that it is electrically insulated from the X-ray tube 9 via an electrical insulator 2. In a transmission tube head, the target 1 also forms, at the same time, the end of the vacuum 7 of the X-ray tube 9. The target 1 must also be able to be moved as after a certain period of use the radiation-generating material (e.g. tungsten) of the target element 11, 11a, 11b is “consumed” or burnt in. For this, the target 1 is turned such that the electron beam 6 strikes an unconsumed position of the target element 11, 11a, 11b. The replacement of the target 1 should also be very simple, in order to be able ensure a fast target change in accordance with the requirements of the inspection task. External magnetic fields must be avoided in order to prevent the influencing of the electron beam 6 (also of the magnetic lenses 4 bundling this) before the striking on the target 1. This type of the open X-ray tubes 9 is largely used for inspection tasks concerned with very small details and depending on high magnification in the X-ray image. In order to realize this, the test object must be positioned immediately in front of the target 1. For the construction of an additional target identification it is therefore important that no components extend into the “inspection space”.

The following solution approaches serve to identify the target 1 on the X-ray tube 9. Here, the technologies/techniques used are divided into two groups:
contact: a connection is produced between the target 1 and the identification equipment;
contactless: methods are used which can carry out an evaluation without a mechanical connection (e.g.: optical scanning, radio scanning—RFID; magnetic field, capacitive).

Different methods are used.

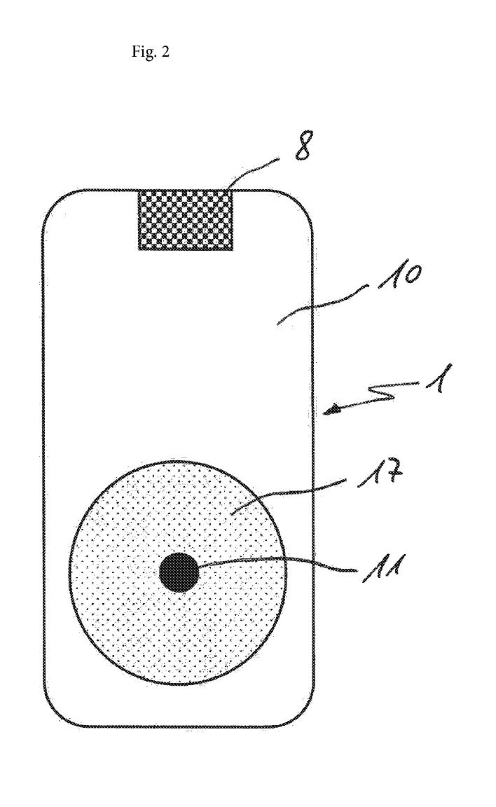

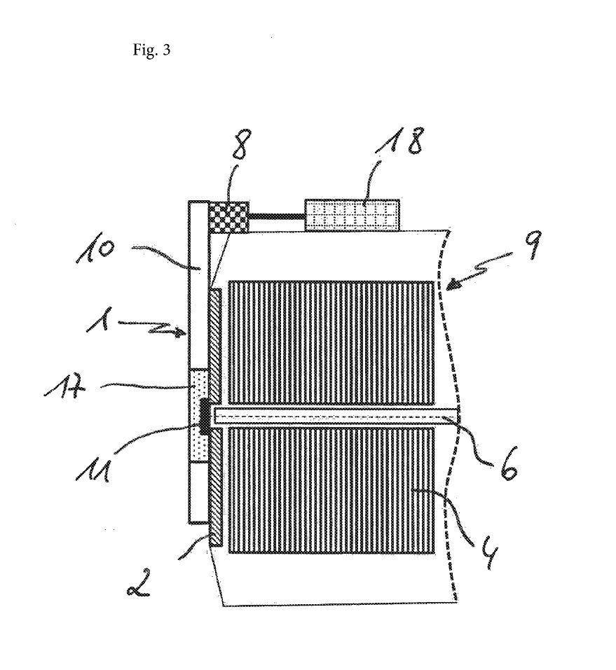

Electrical scanning is explained with reference to FIGS. 2 and 3. Here, two solution approaches are suggested. For example, electronic components 8 are attached to the target 1, which are evaluated via a scanning device, an electrical acquisition element 18. Resistors or a complex electric circuit for example are used as electronic components 8. In the uninstalled state these have no voltage. Through the installation of the target 1, the electronic component 8 is connected, for example by plugs or sliding contacts, to the electrical acquisition element 18. The electrical acquisition element 18 supplies the electronic component 8 with voltage and evaluates the resulting signals. The electrical acquisition element 18 transmits the evaluated signals to a higher-level control system, which then sets the associated parameters for the target 1.

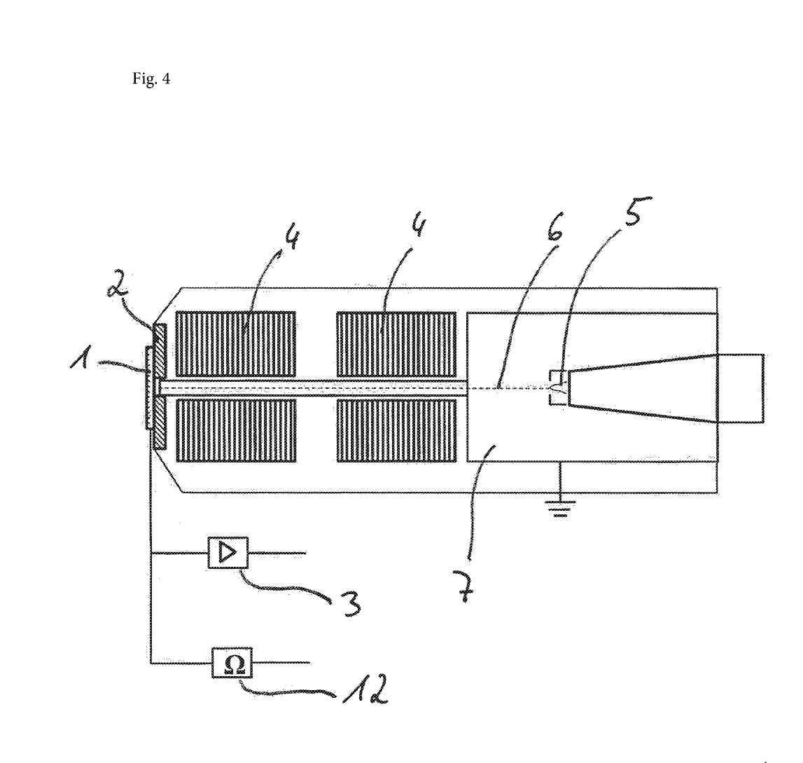

Alternatively to the method according to FIGS. 2 and 3, in an electrical identification, because of the different production, the target 1 can differ even in terms of its electrical behaviour (e.g. by measuring the conductivity) such that an identification is made possible. This is explained with reference to FIG. 4.

The principle is that the material composition of the target 1 differs depending on the design, and this can be detected by an electrical measuring method (e.g. a resistance measurement with suitable measuring voltage by a target resistance meter 12). In order to realize this, the already installed target current measuring device 12 can be extended. As can be seen from FIG. 4, the connections known from FIG. 1 have been extended by a target resistance meter for the target current measurement.

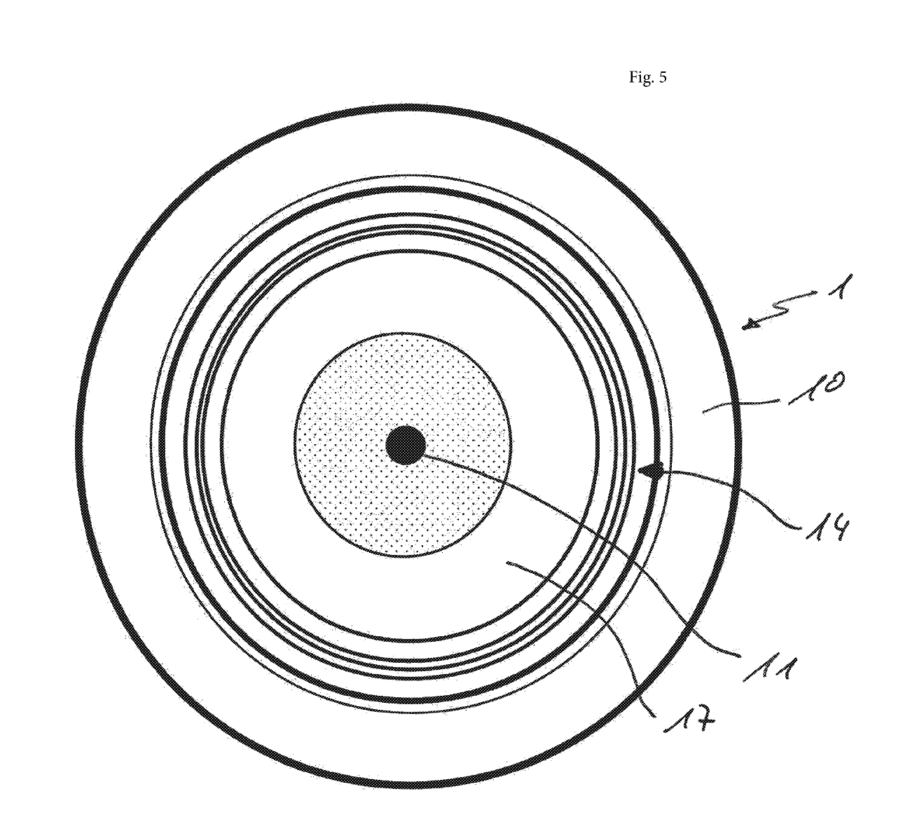

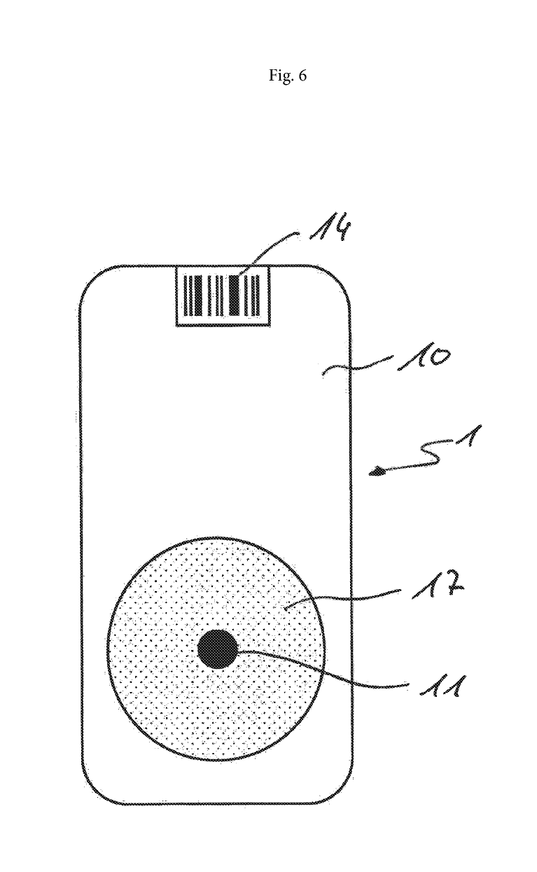

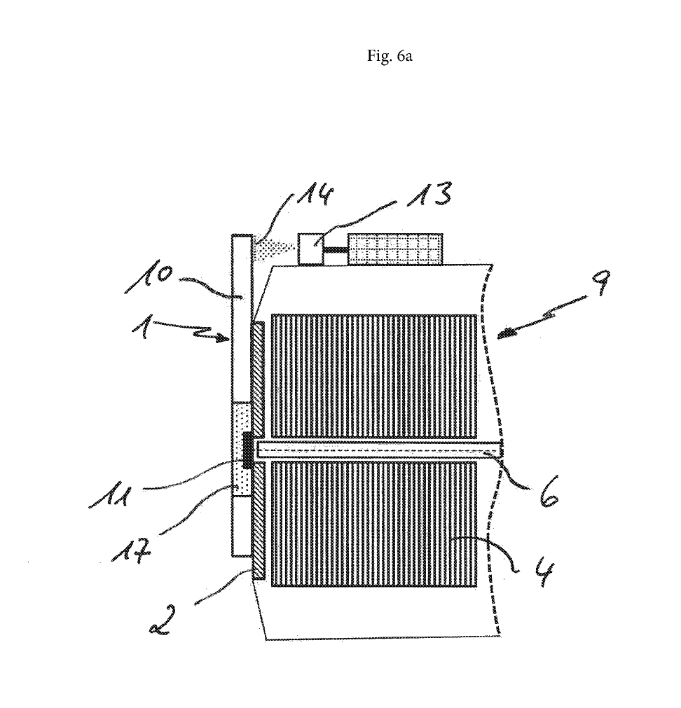

Alternatively to the electrical identification, an optical identification can also be implemented by optical scanning, as is described with reference to FIGS. 5, 6 and 6a.

Here, optical markers are applied to the target base 10 of the target 1, which optical markers are detected by an additional evaluation unit; in the embodiment examples represented, optical identification elements 14 in each case in the form of a barcode are involved. Here, it is possible to carry out a complex query of the barcode or also, alternatively, of a QR code, which can then even contain the serial number of the target 1. In FIG. 5, a rotating target 1 is represented, in which the entire barcode is arranged concentrically around the centre of rotation of the target 1.

In FIGS. 6 and 6a a fixed target 1 is represented, the optical identification element of which (barcode 14)—as in the comparable embodiment example of FIGS. 2 and 3—is arranged at the upper end of the target base 10. In the installation state of the target 1 represented in FIG. 6a, the barcode 14 lies opposite an optical acquisition element 13 attached to the X-ray tube 9. Typical barcode scanners, cameras, but also simple light sensors which detect light-dark differences can be used as optical acquisition elements 13. The optical acquisition element 13 can thereby evaluate the signals originating from the barcode 14. The optical acquisition element 13 transmits the evaluated signals to a higher-level control system, which then sets the associated parameters for the target 1.

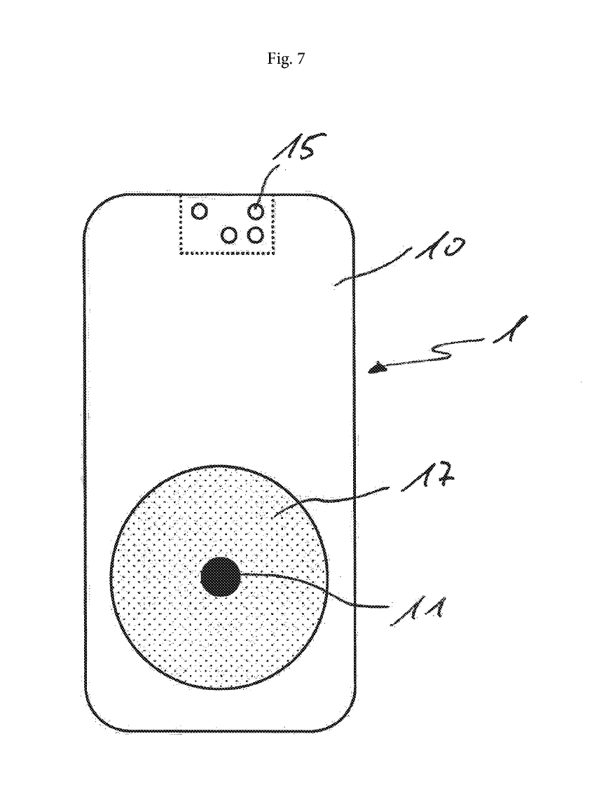

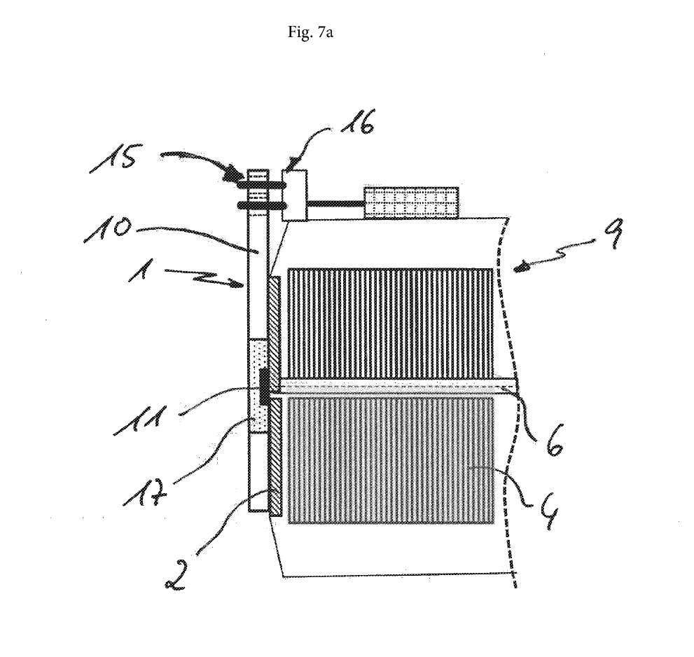

Alternatively to the electrical or optical identification, a mechanical identification, for example with the aid of the device represented in FIGS. 7 and 7a, can also be implemented. The following example shows a possible solution approach in which significant perforations as mechanical identification elements 15 on the target base 10 are queried by a mechanical system/sensor system combination. This can, for example, take place in that the mechanical acquisition element 16 has pins which can be displaced in the longitudinal direction and which can dip into the perforations 15 at the upper end of the target base 10 and it is thus recorded whether a perforation 15 is present at the position associated with the respective pin or not. The mechanical acquisition element 16 transmits the evaluated signals to a higher-level control system, which then sets the associated parameters for the target 1.

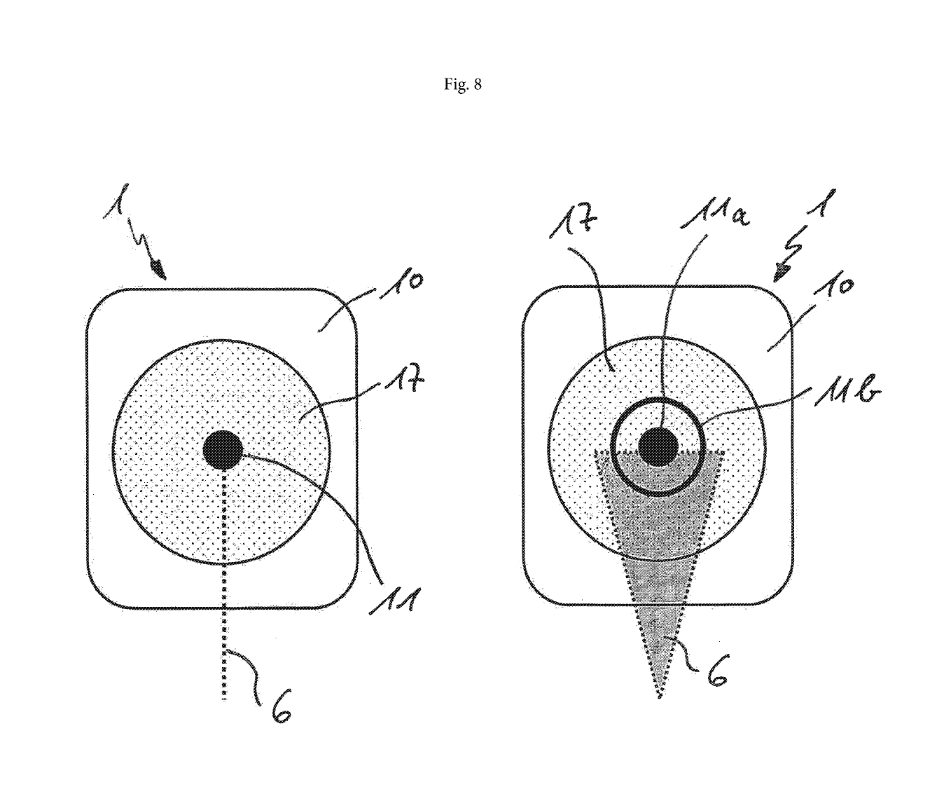

An alternative target identification without using an identification element on the target base 10, as is also represented for example in FIG. 4 (there as electrical identification) is explained with reference to FIG. 8. Here the characteristic radiation resulting from the target 1 is used for identification. Various methods are conceivable.

This solution creates the possibility to evaluate the characteristic radiation property of the target 1 in the imaging chain. There are two solution approaches:
Target 1 remains unchanged (see left part of FIG. 8): the X-ray tube 9 is operated in an operating mode defined for the evaluation and the image resulting from this is evaluated. Each target 1 generates a characteristic radiation due to the setting of the operating values voltage [kV] and current [A]. The radiation can be evaluated by the imaging chain (detector including evaluation unit) installed in an X-ray system. In order to realize this, an operating mode is defined in which all targets 1 of a tube type can be operated. Each time the X-ray tube 9 is started, this operating mode is first started up, in order to then evaluate the radiation which has resulted. The principle of this method is that with the same control parameters each target 1 emits a different radiation.
Target 1 is modified (see right part of FIG. 8): here the target 1 is modified in such a way that by targeted “defocusing”, i.e. enlargement of the electron beam area, the outer surface is also struck and there radiation is generated. The change in the focal spot which is significantly recognizable from this is specific to the target 1 and can be evaluated. In the case represented (right half—the left half represents a conventional target 1), in addition to the circular central target element 11a, a ring-shaped target element 11b spaced apart by a support material 17 is present. Following on from this there is an imaging, which is compared using a focused electron beam 6, i.e. the imaging provides an image the content of which is a uniform grey-scale value. In the case of the defocused electron beam 6, in the present example a ring structure can be recognized. Shapes other than the ring shape of the ring-shaped target element 11b are conceivable.

A magnetic evaluation according to the invention is not represented with reference to figures. It will be explained only briefly how this takes place. Hall probes are attached to the X-ray tube 9 in order to thus evaluate the changes in the magnetic field resulting from a different target 1.

According to the invention, a multi-target can also be used, in which different target elements 11, 11a, 11b (beam generator, such as for example tungsten) or different layer thicknesses of a target element 11, 11a, 11b are applied on the support material 17. Through an automatic positioning, the different target areas can now be positioned in the electron beam 6.

The solution approaches explained above can be extended to the filament 5. Similarly to the target 1, the filament 5 is also decisive for the image quality and is also present in different specifications. The functional principles of the above-described target identification also apply here, but are to be realized in a significantly more difficult environment (completely in the vacuum 7). Nevertheless, an analogous use is possible.

The evaluation electronics and control system environment created for the target identification can be extended relatively easily in order to record additional operating data or properties of the X-ray tube 9. This includes, for example, bending of the X-ray tube 9 when the temperature rises via additionally attached strain gauges, general temperature data or a magnetic field analysis.

Such a target identification is also useful in closed X-ray tubes 9 and the above embodiments predominantly also apply to these. Although it is not possible in this case to change a target 1, the parameters specific to the X-ray tube 9 can also be provided by the target identification system. The identification can be limited to the type or can also relate to the individual target 1 equipped with serial number.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A target for an X-ray tube, comprising:
a target base;
a target element attached to the target base; and
an identification element attached to the target base, the identification element configured to be identified in cooperation with an acquisition element on the X-ray tube and having an unambiguous assignment to characteristics of the target.

2. A filament for an X-ray tube, comprising: a filament holder;
a filament element attached to the filament holder; and
an identification element attached to the filament holder, the identification element configured to be identified in cooperation with an acquisition element on the X-ray tube and having an unambiguous assignment to characteristics of the filament.

3. The target according to claim 1, wherein the identification element is an electrical identification element, an optical identification element or a mechanical identification element.

4. The target according to claim 3, wherein at least one of the electrical identification element is an electronic component, or an RFID chip, the optical identification element is a barcode or a QR code, and the mechanical identification element comprises perforations, serrations or indentations.

5. An X-ray tube comprising the target according to claim 1, wherein the acquisition element cooperates with the identification element.

6. The X-ray tube according to claim 5, wherein the acquisition element is an electronic scanning device, an optical camera, a mechanical system or a sensor system

7. A method for identifying a specific target according to claim 1, wherein the acquisition element attached to the X-ray tube identifies the identification element attached to the target base, and the target is unambiguously assigned to the identification element by a database.

8. A method for identifying a specific filament according to claim 2, wherein the specific filament is unambiguously identified by a Hall probe attached to the X-ray tube, on the basis of a detected magnetic field value of the filament, by data of the filament stored in a database.

9. A method for identifying a specific target according to claim 1, wherein at least one of an electrical behaviour of the target and a conductivity of the target, is measured via a resistance measurement.

10. A method for identifying a specific target according to claim 1, wherein, by an enlargement of an electron beam area on the target element up to an outer surface of the target element, an unambiguous assignment of the target takes place on the basis of a target-specific change in a focal spot.

11. A method for identifying a specific target according to claim 1, wherein when the X-ray tube is started, first a predetermined operating mode which is always the same is started up, in which with fixed control parameters, each target emits a different X-radiation, and the emitted X-radiation is evaluated.

12. A method for automatically setting characteristics of a target installed in an X-ray tube, the X-ray tube comprising a target base, a target element attached to the target base, and an identification element attached to the target base, the identification element configured to be identified in cooperation with an acquisition element on the X-ray tube and which has an unambiguous assignment to characteristics of the target, wherein, after implementation of the method according to claim 7, the characteristics stored in the database for the respective identification element or the target, are transferred to setting devices for the respective characteristics and the characteristics are set by way of the setting devices.

13. The filament according to claim 2, wherein the identification element is an electrical identification element, an optical identification element or a mechanical identification element.

14. The filament according to claim 13, wherein at least one of the electrical identification element is an electronic component or an RFID chip, the optical identification element is one of a barcode and a QR code, and the mechanical identification element comprises perforations, serrations or indentations.

15. An X-ray tube comprising the filament according to claim 2, wherein the acquisition element cooperates with the identification element.

16. The X-ray tube according to claim 15, wherein the acquisition element is an electronic scanning device, an optical camera, a mechanical system or a sensor system.

17. A method for identifying a specific filament according to claim 2, wherein the acquisition element attached to the X-ray tube identifies the identification element attached to the filament holder, and the filament is unambiguously assigned to the identification element by a database.

18. A method for identifying a specific target according to claim 1, wherein the specific target is unambiguously identified by a Hall probe attached to the X-ray tube, on the basis of a detected magnetic field value of the target, by data of the target stored in a database.

19. A method for automatically setting characteristics of a filament installed in an X-ray tube, the X-ray tube comprising a filament holder, a filament element attached to the filament holder, and an identification element attached to the filament holder, the identification element configured to be identified in cooperation with an acquisition element on the X-ray tube and which has an unambiguous assignment to characteristics of the filament, wherein, after implementation of the method according to claim 8, the characteristics stored in the database for the respective identification element or the filament, are transferred to setting devices for the respective characteristics and the characteristics are set by way of the setting devices.
